(19) United States
(12) Patent Application Publication
(10) Pub. No.: US 2012/0324698 A1
(43) Pub. Date: Dec. 27, 2012

(54) TIRE CAVITY COVER AND METHOD OF PROTECTING

(76) Inventor: William James Kannengieser, Conyers, GA (US)

(21) Appl. No.: 13/314,750

(22) Filed: Dec. 8, 2011

Related U.S. Application Data
(60) Provisional application No. 61/501,357, filed on Jun. 27, 2011.

(51) Int. Cl. B23P 11/00; B32B 3/06; B32B 37/14

(52) U.S. Cl. 29/428; 156/293; 428/99

(57) ABSTRACT

A tire cavity cover to seal the cavity formed between the pair of beads of a tire including a cover member configured to be inserted approximate the beads of the tire, the cover member further comprising a pair of coupling members configured to each receive one of the beads of the tire and, thus such apparatus, functions to eliminates the need (time and effort) for cleaning and significantly reduces tire and tire bead deterioration caused by damaging agents, reduce the time spent cleaning road debris from within the tire cavity and on the tire bead, and protect the bead of the tire and sidewall from damage.

### PRIORITY CLAIM TO RELATED US APPLICATIONS

To the full extent permitted by law, the present United States Non-Provisional patent application claims priority to and the full benefit of United States Provisional patent application entitled “Tirelid”, filed on Jun. 27, 2011, having assigned Ser. No. 61/501,357, incorporated entirely herein by reference.

### TECHNICAL FIELD

The disclosure generally relates to a tire or spare tire special receptacle or package and, more specifically, is related to a partial encasement, cover or shield.

### BACKGROUND

Present day commercial trucks and long haul rigs or tractor-trailers typically travel with a rimless spare tire in case of a tire failure such as a flat tire. The rimless spare tire may be slung over a spare tire carrier mounted on the underside of a semi-trailer or attached on the backside of a tractor cab and transported until the spare tire is needed. In addition, the spare tire is often locked in place by positioning a chain or cable through the tire center hole and locking the chain or cable to the truck. In the event of a tire failure, a roadside service technician or mechanic changes the failed tire by dismounting the failed tire from the tire rim and mounting the spare tire to the tire rim.

During transport of the spare tire, the spare tire is exposed to dirt, mud, sand, rock, salt, water and other road debris. Therefore, prior to mounting the spare tire all debris must be removed from the tire cavity and the bead of the tire sidewall must be thoroughly cleaned before mounting the spare tire on the tire rim.

Moreover, when rimless tires are stored inside, such as in a warehouse or outside, they are exposed to damaging agents such as debris, animal nests, sand, humidity, water, dust, and others. As a consequence the rimless tires need to be thoroughly cleaned before mounting on a tire rim for use. Furthermore, the above elements deteriorate the tire and the tire beads quality throughout time.

When an airplane tire is being stored the tire is fitted with two hard plastic hubcap devices with a bolt running through the hubcap center point pulling the hubcap devices together to seal the tire from contaminants. Often the bolt extends beyond the width of the tire compromising the stackability or palletizing capability of the protected tires.

Therefore, it is readily apparent that there is a recognizable unmet need for a tire cavity cover and method of protecting that eliminates the need (time and effort) for cleaning and significantly reduces tire and tire bead deterioration caused by damaging agents, reduces the time spent cleaning road debris from within the tire cavity and on the tire bead, and decreases the dirt or residue accumulating on the bead of the tire and sidewall by covering the tire cavity and bead portion of the tire sidewalls.

### SUMMARY

Briefly described, in an example embodiment, the present apparatus and method overcomes the above-mentioned disadvantages and meets the recognized need for a tire cavity cover and method of protecting comprising, in general, a flexible planar member configured with a first lengthwise edge and a second lengthwise edge; a pair of groves, a first lengthwise groove configured approximate the first lengthwise edge and a second lengthwise groove configured approximate the second lengthwise edge of the flexible planar member and, thus such apparatus, functions to eliminates the need (time and effort) for cleaning and significantly reduces tire and tire bead deterioration caused by damaging agents, reduce the time spent cleaning road debris from within the tire cavity and on the tire bead, decreases the dirt or residue that accumulates on the bead of the tire and sidewall, and protect the beads of the tire sidewall from damage.

According to its major aspects and broadly stated, the present apparatus meets the recognized need for a tire cavity cover to cover and seal the cavity formed between beads of a tire and cover the beads themselves comprising a cover member configured to be inserted approximate the beads of the tire, the planar member further comprising at least one coupling member formed integral with the planar member and configured to receive at least one of the beads of the tire.

In a further exemplary embodiment, a tire cavity cover to seal the cavity formed between the pair of beads of a tire comprising a cover member configured to be inserted approximate the beads of the tire, the planar member further comprising a pair of coupling members configured to each receive one of the beads of the tire.

In a further exemplary embodiment of a method of shielding the cavity formed between beads of a tire from debris comprising the steps of providing a cover member configured to be inserted approximate the beads of the tire, the planar member further comprising at least one coupling member formed integral with the planar member, positioning the cover member approximate the cavity formed between beads of a tire, and affixing the at least one coupling member to at least one of the beads of the tire.

Accordingly, a feature of the tire cavity cover and method of protecting is its ability to reduce the time spent cleaning road debris from within the spare tire cavity and the beads themselves prior to mounting the spare tire or tire.

Another feature of the tire cavity cover and method of protecting is its ability to decreases the dirt or residue that accumulates on the bead of the tire and sidewall prior to mounting the spare tire or tire.

Yet another feature of the tire cavity cover and method of protecting is its ability to significantly reduce the deterioration caused during transportation and/or storage of the tire caused by damaging elements such as debris, animal nests, sand, humidity, water, dust, and others of the tire cavity and the bead and to preserve the proper function of the tire such as inflatability properties and seal between the tire rim and tire bead.

Still another feature of the tire cavity cover and method of protecting is its ability to accommodate a variety of spare tires or tires, such as size, angle of bend of bead or sidewall of the spare tire.

Yet another feature of the tire cavity cover and method of protecting is its ability to provide a stylish tire cavity cover that may be fitted to a tire for display, marketing and sales purposes.

Yet another feature of the tire cavity cover and method of protecting is its ability to provide a low cost tire cavity cover that may be fitted to a tire shortly after manufacture.

Yet another feature of the tire cavity cover and method of protecting is its ability to fit within the tire width adding no additional width to the tire maintaining current packaging and distribution methods.

Yet another feature of the tire cavity cover and method of protecting is its ability to provide full access to the tire hole to maintain current sorting, distribution and delivery methods.

Yet another feature of the tire cavity cover and method of protecting is its ability to provide full access to the tire hole to enable insertion of a cable or chain for security purposes, such as chaining the tire to the trailer bracket.

Yet another feature of the tire cavity cover and method of protecting is its ability to provide full access to the tire hole to enable easy access, lifting and transport of the tire.

Yet another feature of the tire cavity cover and method of protecting is its ability to be laid flat or rolled for storage when not in use.

These and other features of the trim assembly will become more apparent to one skilled in the art from the following Brief Description of the Drawings, Detailed Drawings, Detailed Description and Claims when read in light of the accompanying drawings.

### BRIEF DESCRIPTION OF THE DRAWINGS

The present garment with carrying pouch and support system or the like will be better understood by reading the Detailed Description of the embodiments with reference to the accompanying drawings, in which like reference to numerals denote similar structures and refer to like elements throughout, and in which:

FIG. 1 is a perspective view of a tire or spare tire;

FIG. 2 is a top view of an example embodiment of the tire cavity cover;

FIG. 3 is a cross-sectional sectional side view of an example embodiment of the tire cavity cover shown in FIG. 2;

FIG. 4A is a perspective view of a tire or spare tire shown with an example embodiment of the tire cavity cover inserted therein;

FIG. 4B is a cross-sectional view of an example embodiment of the tire cavity cover approximate the tire shown in FIG. 4A;

FIG. 5 is a cross-sectional view of an example embodiment of the tire cavity cover engaged with the tire shown in FIG. 4A; and

FIG. 6 is a flow diagram of a method of protecting or shielding the inner cavity of a tire from road debris.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

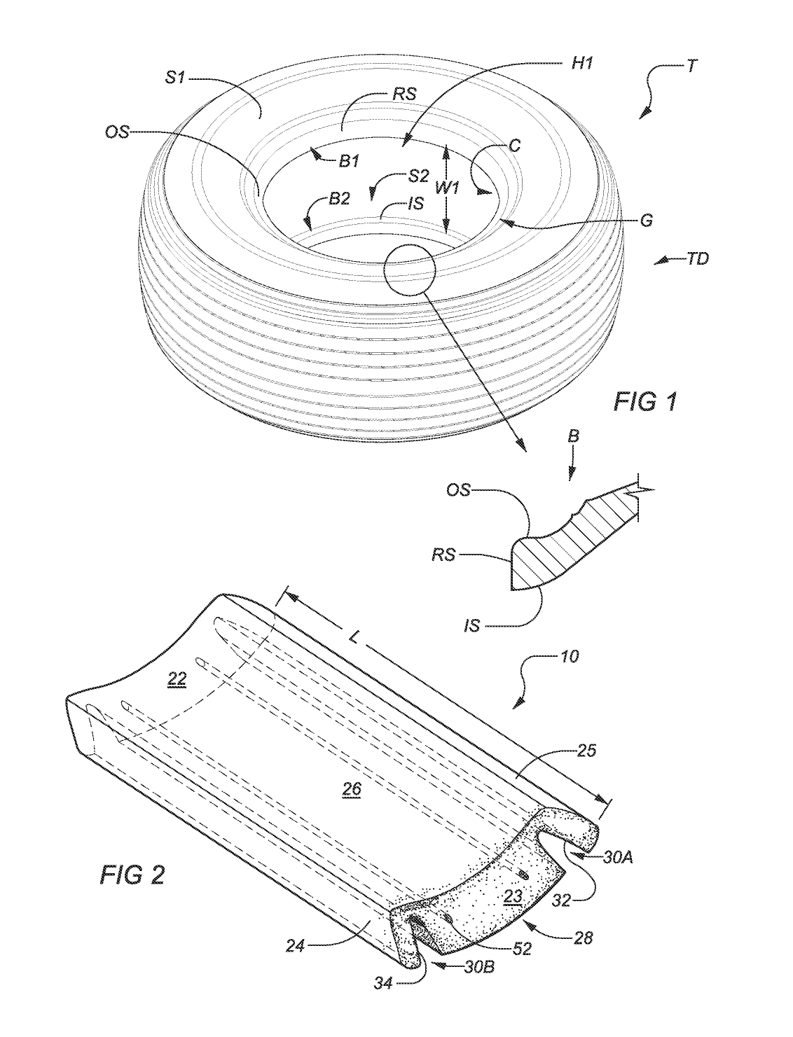

In describing the exemplary embodiments of the present disclosure, as illustrated in FIGS. 1-6 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1 there is illustrated a perspective view of a sample tire T. A tire T is a pneumatic inflatable ring or doughnut-shaped covering that fits around a tire rim of a motor vehicle or other transportation device to provide enhanced performance by providing flexible material that absorbs shock while maintaining the tire in close contact with the ground. Tire T preferably includes any motor vehicle or transportation tire such as modern day radial tires. Radial tires are rubber tires with a network of cords, called carcass, such as polyester, steel or other material, that give tire strength and shape. The network of cords includes bias-ply which are at angles of about +60 and −60 degrees from the direction of travel and radial-ply which are at angles of about 90 degrees from the direction of travel. The network of cords may run from bead B1 through sidewall S1 under the tread Td through the other sidewall S2 and terminate at the other bead B2. Moreover, network of cords may criss-cross or be layered throughout and encased in rubber to form the tire T a hollow ring with an inner cavity C having a circumference G and width W1.

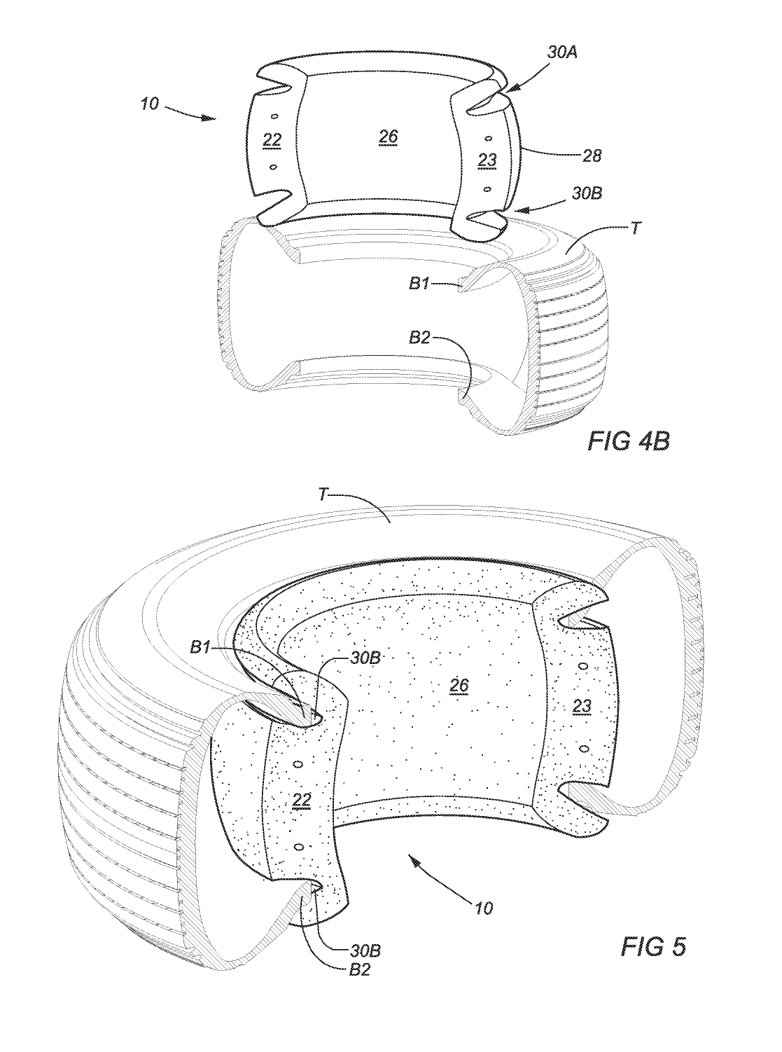

Each bead B (of a pair of beads or circular beads B) portion of tire T includes a radial inner surface IS and also a radial outer surface OS of a predetermined height that extends in a generally radial direction. The inner surface IS and outer surface OS of bead B portion of tire T are connected to one another by axial surface RS (which may be a point or seam) and each inner surface IS and outer surface OS at a predetermined angle with respect to the axis of rotation of tire T (shown in FIG. 4). Moreover, inner surface IS, outer surface OS, and axial surface RS form hole H1 in tire T. The dimensions and orientation of the surfaces of the bead portion of a tire are selected by a tire engineer in accordance with well known engineering practices so that the bead portions will mate properly with a rim or rim edges that the tire T is designed to be mounted upon.

As used herein “axis” refers to the axis of rotation of tire T and “axial” and “axially” refers to directions parallel to said axis. “Radial” and “radially” refer to directions that is perpendicular to said axis.

Tires T are used on many types of vehicles or transportation devices, such as bicycles, wagons, motorcycles, wagons, trailers, cars, trucks, earthmovers, farm equipment, aircraft and the like. Tire T is preferably formed of a suitable material, such as synthetic rubber, natural rubber, fabric, wire, stainless steel, aluminum, metal, metal alloys, shape memory alloys, carbon fibers, along with other compound chemicals or the like, capable of providing structure to tire T. Preferably, the material includes other suitable characteristics, such as durability, flexibility, light weight, wearability, inflatability, chemical inertness, oxidation resistance, ease of workability, or other beneficial characteristic understood by one skilled in the art.

Referring now to FIG. 2 by way of example, and not limitation, there is illustrated an example embodiment tire inner cavity shield or cover member such as tire cavity cover 10. Preferably, tire cavity cover 10 includes a formed, cut or shaped polygon configured as a flexible planar member, surface, or strip having one or more sides 22, 23, 24, and 25, top 26, and bottom 28 arranged preferably as a rectangle with rounded ends. It is contemplated herein that configurations other than rectangular for tire cavity cover 10 may be utilized herein known to one of ordinary skill in the art. Tire cavity cover 10 is preferably formed, molded or configured from a suitable material, such as expanded polypropylene, polyethylene, polystyrene, polyurethane or alternative resin: plastic, paper, cardboard, canvas, rubber, fiber, inflatable material, gel filled material, foam filled material, fiber reinforced, synthetic rubber, natural rubber, fabric, wood, metal, aluminum, alloy, stainless steel, shape memory metal, wire, stips, or any flexible material or the like and any manufacturing method, capable of providing structure to tire cavity cover 10. Preferably, the material includes other suitable characteristics, such as strength, durability, water-resistance, thermal neutrality, clean-ability, light weight, pliability, durability, flexibility, wearability, inflatability, resilience, chemical inertness, oxidation resistance, safety, smoothness, ease of workability, longevity, or other beneficial characteristic understood by one skilled in the art. Sides 22, 23, 24, and 25, top 26, and bottom 28 may include a rich-textured or luxurious fabric sheet or surface layer such as cotton, linen, velvet, flock, faux leather (Vienna™), faux suede, silk, burlap, indicia, trademark or the like, or a high friction material, such as a soft rubber or polymer, an adhesive, or the like covering an exterior surface of tire cavity cover 10 or marked with an indicia or trademark to provide a high end appearance for show room displays of tire T. Preferably, sides 22, 23, 24, and 25, top 26, and bottom 28 may be configured to be curved or contoured.

In a preferred embodiment, tire cavity cover 10 has approximate dimensions length×width, wherein the length L of sides 24 and 25 are preferably as great as the circumference G of cavity C of tire T and the width W of sides 22 and 23 are preferably as great as the width W1 of cavity C (distance between beads B) of tire T. It is recognized herein that tire cavity cover 10 may include dimensions other than those set forth above.

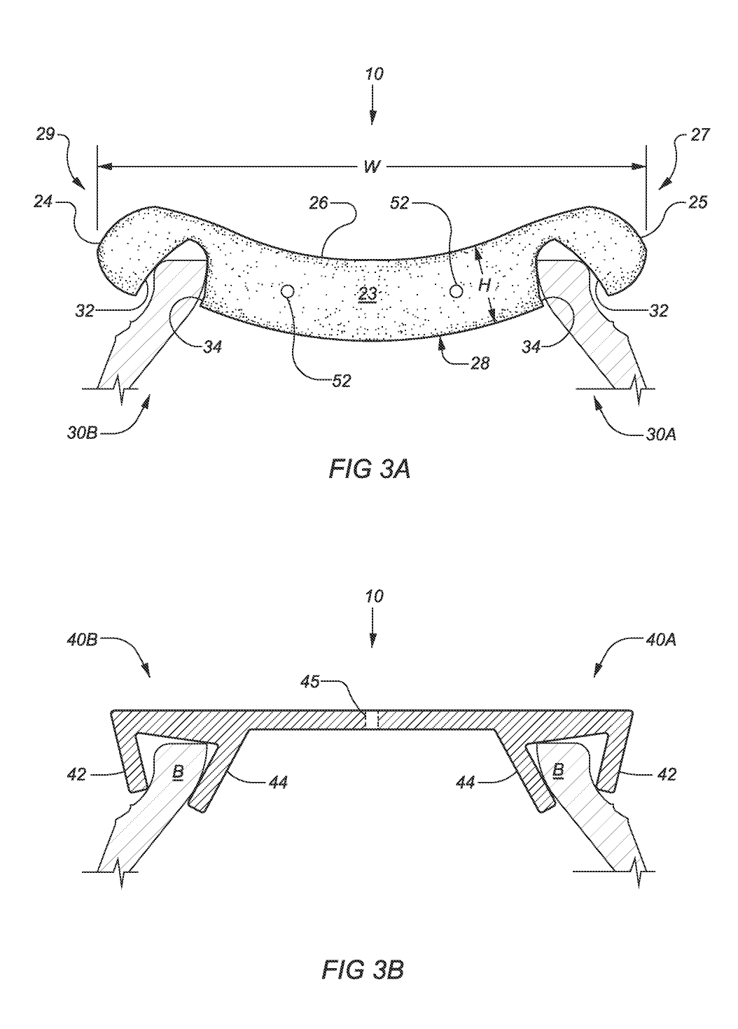

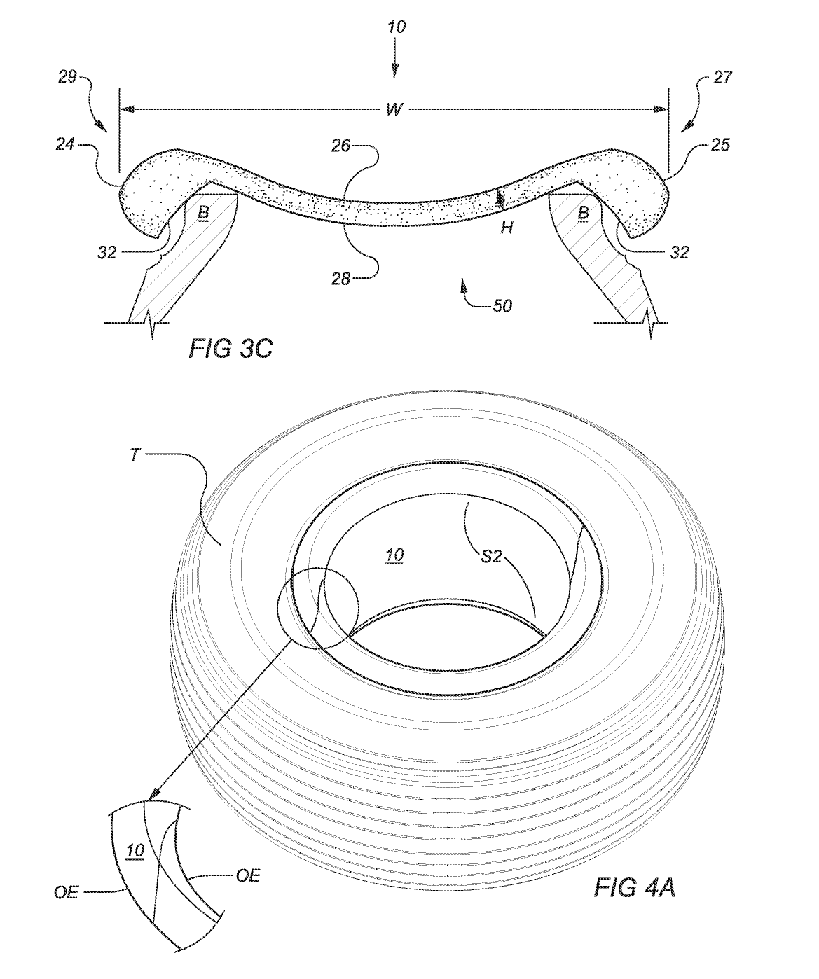

Referring now to FIG. 3A, there is illustrated a cross-sectional view of an example embodiment of tire cavity cover 10. Preferably, tire cavity cover 10 includes top 26, bottom 28, side 23, first end 27, second end 29, coupling member 30A, and coupling member 30B. Preferably, first end 27 and second end 29 may be configured as rounded or bull nose shaped but other shapes are contemplated herein. In a preferred embodiment, tire cavity cover 10 has an approximate dimension height H that is greater than the height of inner surface IS and outer surface OS of beads B of tire T. It is recognized herein that height H may include dimensions other than those set forth above.

In addition, tire cavity cover 10 includes one or more cutouts, grooves, jaws, bead seat or fingers such as coupling member 30 configured to fit or encompass bead B of tire T. Coupling member 30 preferably includes at least first sidewall 32 and second sidewall 34 to form a u-shaped groove running the approximate length of sides 24 and 25 of tire cavity cover 10 (as shown in FIG. 2). It is recognized herein that coupling members 30 may be configured in shapes other than u-shaped to accommodate any dimension and shape of beads B of tire T.

Referring now to FIG. 3B, there is illustrated a cross-sectional view of an example embodiment of tire cavity cover 10. In another example embodiment, coupling members 40A/B may include a pair of jaw or a gripper, having one or more jaw, finger or pincher, such as first finger 42 and second finger 44 preferably configured to releasably engage and connect tire cavity cover 10 to beads B of tire T. It is contemplated herein that coupling members 40 may be configured in a variety of shapes and sizes to accommodate beads B of tire T.

It is further contemplated herein that tire cavity cover 10 may include one or more pin holes, vents or other apertures 45 to enable venting of air or moisture to maintain ambient conditions within cavity C of tire T.

Referring now to FIG. 3C, there is illustrated a cross-sectional view of an example embodiment of tire cavity cover 10. In another example embodiment, coupling members 30 may include a channel, cutout or slot such as coupling member 50 preferably configured to releasably engage and connect tire cavity cover 10 to beads B of tire T. It is contemplated herein that coupling members 50 may be configured in a variety of shapes and sizes to accommodate beads B of tire T. Coupling member 50 preferably includes at least first sidewall 32 to form a channel running the approximate length of sides 24 and 25 of tire cavity cover 10.

Referring now to FIG. 4A, there is illustrated a perspective view of a tire T shown with an example embodiment of tire cavity cover 10 inserted therein and, thus, seal cavity C of tire T from debris. It is further contemplated herein that tire cavity cover 10 may include one or more segments S2 of tire covers connected together, end to end or overlapping or the like, to form tire cavity cover 10 which covers the circumference G of cavity C of tire T. Moreover overlapping ends OE or angled ends may be added to facilitate complete coverage of circumference G of cavity C of tire T.

Referring now to FIG. 4B, there is illustrated a cross-sectional view of an example embodiment of tire cavity cover 10 approximate with tire cavity cover 10. In use, tire cavity cover 10 is positioned approximate hole H1 in tire T and coupling members 30 are preferably aligned approximate beads B (B1 and B2) of tire T. When tire cavity cover 10 is in this position, tire T and tire cavity cover may be pushed or forced together to cause coupling members 30 to engage beads B of tire T and, thus, preferably releasably affix or connect tire cavity cover 10 to tire T.

Referring now to FIG. 5, there is illustrated a cross-sectional view of an example embodiment of tire cavity cover 10 engaged with tire cavity cover 10. In use, tire cavity cover 10 is positioned approximate hole H1 in tire T and coupling members 30 are preferably aligned approximate beads B of tire T. When tire cavity cover 10 is in this position, tire T and tire cavity cover 10 may be pushed or forced together to cause coupling members 30 to engage beads B of tire T shown herein and, thus, preferably releasibly connect or affix tire cavity cover 10 to tire T. Preferably coupling member 30A and coupling member 30B of tire cavity cover 10 are designed to accommodate, cover, affix or fit at least a portion of inner surface IS, outer surface OS and axial surface RS (shown in FIG. 4A) of beads B (B1 and B2) to releasibly connect or affix tire cavity cover 10 to tire T and, thus, seal cavity C of tire T from debris. Moreover, the depth of coupling member 30A and coupling member 30B should preferably be about the same as the height of inner surface IS, outer surface OS (shown in FIGS. 1 and 3A), but in any event the depth of coupling member 30A and coupling member 30B must be deep enough to connect or affix tire cavity cover 10 to tire T.

It is contemplated herein that tire cavity cover 10 may be configured with minimum depth of coupling members 30 to enable a frictional fit or connection between tire cavity cover 10 to tire T to maintain the position of tire cavity cover 10 relative to beads B of tire T, and, thus, seal cavity C of tire T from debris.

It is further contemplated herein that tire cavity cover 10 may be configured with no depth to coupling members 30 to enable a frictional fit or connection between tire cavity cover 10 to tire T to maintain the position of tire cavity cover 10 relative to beads B of tire T, and, thus, seal cavity C of tire T from debris. In this example embodiment, coupling members 30 is the surface area of side 28 in contact with to beads B of tire T. Furthermore, tire cavity cover 10 may include shape memory material such as a wire 52 (shown in FIGS. 2, 3A and 4B) within tire cavity cover 10 to enable a frictional fit or connection between tire cavity cover 10 to tire T to maintain the position of tire cavity cover 10 relative to beads B of tire T.

It is still further contemplated herein that when tire cavity cover 10 tire is connected to tire T sealing the cavity C of tire T from debris and, thus, preventing debris from entering the inside of tire T.

Preferably, coupling members 30A and 30B are configured to have a width and depth at least as great as the width and height of bead B1 and the other bead B2 and a spacing therebetween equal to that of the distance between bead B1 and the other bead B2 to accommodate insertion therein of bead B1 and the other bead B2 of tire T into coupling members 30A and 30B.

Preferably, coupling members 30A and 30B are configured to have a shape and size to accommodate, affix, fit or cover at least a portion of bead B1 and the other bead B2 of tire T into coupling members 30A and 30B.

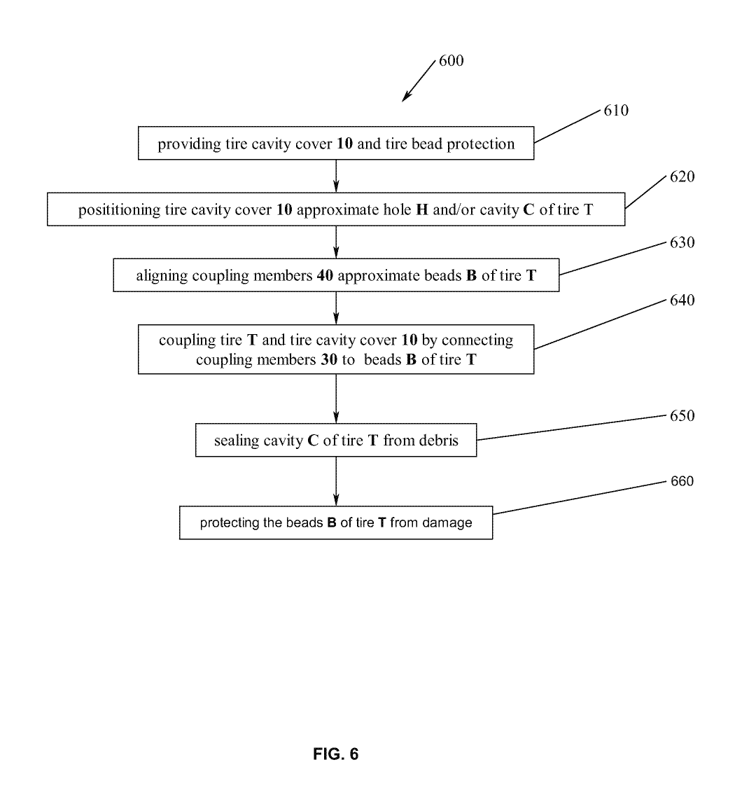

Referring now to FIG. 6, there is illustrated a flow diagram 600 a method of protecting or shielding the inner cavity C of tire T from debris. In block or step 610, providing tire cavity cover 10 configured as a formed, cut or shaped polygon configured as a flexible planar strip having one or more sides 22, 23, 24, and 25, top 26, and bottom 28, wherein bottom 28 preferably includes coupling members 30 for gripping or connecting to beads B of tire T, as described above in FIGS. 1-5. In block or step 620, positioning tire cavity cover 10 approximate hole H1 and/or cavity C of tire T. In block or step 630, aligning coupling members 30/40 approximate beads B of tire T. In block or step 640, coupling or affixing tire T and tire cavity cover 10 by pushing or forcing coupling members 30 to engage beads B of tire T. In block or step 650, sealing cavity C of tire T from debris. In block or step 660, protecting beads B of tire T from damage.

The foregoing description and drawings comprise illustrative embodiments of the present invention. Having thus described exemplary embodiments, it should be noted by those ordinarily skilled in the art that the disclosures within are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains, having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

Therefore, at least the following is claimed:

1. A tire cavity cover to seal the cavity formed between beads of a tire comprising:
a cover member configured to be inserted approximate the beads of the tire, said cover member further comprising at least one coupling member formed integral with said planar member and configured to receive at least one of the beads of the tire.

2. The tire cavity cover of claim 1, wherein said at least one coupling member further comprises a pair of coupling members configured to each receive one of the beads of the tire.

3. The tire cavity cover of claim 1, wherein said cover member is planar.

4. The tire cavity cover of claim 1, wherein said cover member is flexible.

5. The tire cavity cover of claim 1, wherein said at least one coupling member is configured to be removably affixed to one of the beads of the tire.

6. The tire cavity cover of claim 1, wherein said at least one coupling member is configured to accept at least one of the beads of the tire.

7. The tire cavity cover of claim 1, wherein said at least one coupling member is configured to be approximately u-shaped.

8. The tire cavity cover of claim 1, wherein said at least one coupling member is configured to run lengthwise said cover member.

9. The tire cavity cover of claim 1, wherein said cover member is selected from the group consisting of polypropylene, polyethylene, polystyrene, polyurethane, plastic, paper, cardboard, rubber and combinations thereof.

10. The tire cavity cover of claim 1, wherein said cover member further comprises at least one surface layer.

11. The tire cavity cover of claim 10, wherein said at least one surface layer is selected from a group consisting of textured fabric, cotton, linen, velvet, flock, faux leather (VIENNA), faux suede, burlap, rubber, polymer, indicia, and screened mark.

12. The tire cavity cover of claim 1, wherein said cover member further comprises a plurality of modular cover members.

13. The tire cavity cover of claim 12, wherein said plurality of modular cover members further comprises an overlapping transition therebetween.

14. The tire cavity cover of claim 1, wherein said at least one coupling member further comprises a pair of jaws.

15. The tire cavity cover of claim 1, wherein said cover member further comprises a vent formed therein.

16. A tire cavity cover to seal the cavity formed between the pair of beads of a tire comprising:
a cover member configured to be inserted approximate the beads of the tire, said cover member further comprising a pair of coupling members configured to each receive one of the beads of the tire.

17. The tire cavity cover of claim 16, wherein said pair of coupling member is configured to be removeably affixed to the pair of beads of the tire.

18. The tire cavity cover of claim 16, wherein said cover member further comprises a plurality of modular cover members.

19. The tire cavity cover of claim 18, wherein said plurality of modular cover members further comprises an overlapping transition therebetween.

20. The tire cavity cover of claim 16, wherein said pair of coupling members is configured to be approximately u-shaped.

21. The tire cavity cover of claim 16, wherein each said pair of coupling members further comprises a pair of jaws.

22. The tire cavity cover of claim 16, wherein said cover member further comprises a vent formed therein.

23. A method of shielding the cavity formed between beads of a tire from debris comprising the steps of:
providing a cover member configured to be inserted approximate the beads of the tire, said planar member further comprising at least one coupling member formed integral with said planar member;
positioning said cover member approximate the cavity formed between beads of a tire; and
affixing said at least one coupling member to at least one of the beads of the tire.

24. The method of claim 23, further comprises the step of sealing the cavity formed between the beads of a tire from debris.

25. The method of claim 23, further comprises the step of protecting the beads of the tire from damage.
